(19) United States
(12) Patent Application Publication
(10) Pub. No.: US 2015/0201249 A1
(43) Pub. Date: Jul. 16, 2015

(54) METHOD AND APPARATUS FOR RECEIVING BROADCASTING CHANNEL

(71) Applicant: Samsung Electronics Co., Ltd., Gyeonggi-do (KR)

(72) Inventors: Jin-Bong RYU, Gyeonggi-do (KR); Kye-Hwan LEE, Gyeonggi-do (KR); Seung-Bum LEE, Gyeonggi-do (KR); Seung-Hwan CHO, Gyeonggi-do (KR)

(73) Assignee: Samsung Electronics Co., Ltd.

(21) Appl. No.: 14/593,658

(22) Filed: Jan. 9, 2015

(30) Foreign Application Priority Data
Jan. 10, 2014 (KR) 10-2014-0003639
May 23, 2014 (KR) 10-2014-0062444

(51) Int. Cl. H04N 21/6405; H04N 21/236

(52) U.S. Cl. CPC H04N 21/6405; H04N 21/236

(57) ABSTRACT

An electronic device and a method are provided. The method includes receiving first content data corresponding to a first broadcasting channel while receiving second content data corresponding to a second broadcasting channel; and outputting at least a part of the received first content data to a display connected to the electronic device.

### PRIORITY

This application claims priority under 35 U.S.C. §119(a) to a Korean patent applications filed on January 10 and May 23, 2014, in the Korean Intellectual Property Office and assigned Serial Nos. 10-2014-0003639 and 10-2014-0062444, respectively, the entire content of each of which is incorporated herein by reference.

### BACKGROUND OF THE INVENTION

1. Field of the Invention

The present invention relates generally to a method and apparatus for receiving broadcast channels, and more specifically, to a method and apparatus for receiving broadcast channels in a broadcasting service provided based on an evolved Multimedia Broadcast and Multicast Service (eMBMS).

2. Description of the Related Art

Service technologies to transfer multimedia content through broadcast or multicast transmissions have been recently introduced and realized. For example, 3rd Generation Partnership Project (3GPP) mobile communication networks provide an evolved Multimedia Broadcast/Multicast Service (eMBMS). The eMBMS service sends multimedia content packets obtained from a data source, e.g., a Content Provider (CP) or a Multicast Broadcast (MB) source server to a number of electronic devices through a mobile communication network in a broadcasting or multicasting method. Accordingly, an eMBMS system sends corresponding content to many users at one time, in order for the users to receive the corresponding content at the same time.

In receiving eMBMS based broadcast, in order to receive multimedia content packet data, only one broadcasting channel is accessed between an electronic device of a user and a network. Thus, when the user wants channel change from one to another, the electronic device must be disconnected from the existing channel and connected to the new channel. This procedure of changing channels causes delay.

### SUMMARY OF THE INVENTION

The present invention has been designed to address at least the above-mentioned problems, and to provide at the advantages described below.

Accordingly, an aspect of the present invention is to provide a method and apparatus to reduce delay in access to a new channel in channel change and thus increase user convenience, by receiving multimedia content packet data from multiple broadcasting channels, simultaneously.

In accordance with an aspect of the present invention, a method in an electronic device is provided. The method includes receiving first content data corresponding to a first broadcasting channel while receiving second content data corresponding to a second broadcasting channel; and outputting at least a part of the received first content data to a display connected to the electronic device.

In accordance with another aspect of the present invention, an electronic device is provided. The electronic device includes a memory for storing content data; and a broadcasting service module connected to the memory, wherein the broadcasting service module is configured to receive first content data corresponding to a first broadcasting channel while receiving second content data corresponding to a second broadcasting channel, and output at least a part of the received first content data to a display connected to the electronic device.

A non-transitory computer-readable recording medium having a program stored thereon for performing a method is provided. The method includes receiving first content data corresponding to a first broadcasting channel in an electronic device while receiving second content data corresponding to a second broadcasting channel; outputting at least a part of the received first content data to a display connected to the electronic device; and processing, while outputting the at least the part of the received first content data, at least a part of the received second content data, the processing including at least one of buffering and reproducing the at least the part of the received second content data.

### BRIEF DESCRIPTION OF THE DRAWINGS

The above and other aspects, features, and advantages of certain embodiments of the present invention will become more apparent to those skilled in the art from the following description taken in conjunction with the accompanying drawings, in which:

FIG. 1 is a diagram illustrating a concept of a Multimedia Broadcast and Multicast Service (MBMS) system according to an embodiment of the present invention;

FIG. 2 is a diagram illustrating downlink channel mapping used in Multicast Broadcast Single Frequency Network (MBSFN) transmission according to an embodiment of the present invention;

FIGS. 3A, 3B, and 3C are diagrams illustrating downlink frame structures used in a Long Term Evolution (LTE) system according to an embodiment of the present invention;

FIG. 4 is a block diagram illustrating an arrangement of a broadcasting service network, according to an embodiment of the present invention;

FIG. 5 is a diagram illustrating communications between eNode B and an electronic device, according to an embodiment of the present invention;

FIG. 6 is a diagram illustrating a method of MBSFN reception of an electronic device according to an embodiment of the present invention;

FIG. 7 is a diagram illustrating Multicast Channel (MCH) scheduling information according to an embodiment of the present invention;

FIG. 8 is a diagram illustrating a network environment including an electronic device, according to an embodiment of the present invention;

FIG. 9 is a block diagram of a broadcasting service module, according to an embodiment of the present invention;

FIG. 10 is a flowchart illustrating operations of an electronic device, according to an embodiment of the present invention;

FIG. 11 is a flowchart illustrating operations of an electronic device, according to another embodiment of the present invention;

FIGS. 12A and 12B are diagrams illustrating a procedure of processing a broadcasting channel, according to an embodiment of the present invention;

FIG. 13 is a flowchart illustrating operations of an electronic device, according to another embodiment of the present invention;

FIG. 14 is a diagram illustrating a procedure of processing a broadcasting channel, according to another embodiment of the present invention;

FIG. 15 is a flowchart illustrating operations of an electronic device, according to another embodiment of the present invention;

FIG. 16A is a diagram illustrating candidate channels reproduced in the background, according to an embodiment of the present invention;

FIG. 16B is a diagram illustrating a screen of a candidate channel guide, according to an embodiment of the present invention; and

FIG. 17 is a block diagram of an electronic device to which a method for processing a broadcasting channel is applied, according to an embodiment of the present invention.

### DETAILED DESCRIPTION OF EMBODIMENTS OF THE PRESENT INVENTION

The following description refers to various embodiments of the present invention with reference to the accompanying drawings. It includes various specific details to assist in that understanding but these are to be regarded as merely exemplary and various modifications may be made to the embodiments. The embodiments of the invention may, however, be embodied in many different forms and should not be construed as limited to the embodiments set forth herein. Throughout the drawings, like reference numerals will be understood to refer to like parts, components, and structures.

As used herein, the term “and/or” includes any and all combinations of one or more of the associated listed items. For examples, “A or B” may include A, or include B, or include both A and B.

Ordinal numbers as herein used, such as “first”, “second”, etc., may modify various components of various embodiments, but do not limit those components. For example, these terms do not limit order and/or importance of corresponding elements, components, regions, layers and/or sections. These terms are only used to distinguish one element, component, region, layer or section from another region, layer or section. For example, a first user device and a second user device refer to two different user devices. Thus, a first element, component, region, layer or section discussed below could be termed a second element, component, region, layer or section without departing from the teachings of the embodiments of the present invention. When the term “connected” or “coupled” is used, a component may be directly connected or coupled to another component or may be indirectly connected or coupled to another component via another new component.

However, if a component is said to be “directly connected” or “directly coupled” to another component, it should be interpreted as literally as it says. The terminology used herein is merely for the purpose of describing particular embodiments only and is not intended to limit embodiments of the present invention. It is to be understood that the singular forms “a,” “an,” and “the” include plural references unless the context clearly dictates otherwise.

Unless otherwise defined, all terms including technical and scientific terms used herein have the same meaning as commonly understood by one of ordinary skill in the art to which the embodiments of the present invention belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An electronic device according to various embodiments of the present invention may have a broadcasting channel reception functionality. For example, the electronic device may include any of, for example, smart phones, tablet Personal Computers (PCs), mobile phones, video phones, e-book readers, desktop PCs, laptop PCs, netbook computers, Personal Digital Assistants (PDAs), Portable Multimedia Players (PMPs), MP3 players, mobile medical devices, cameras, and wearable devices (e.g., Head-Mounted Devices (HMDs), such as electronic glasses, electronic clothes, electronic bracelets, electronic necklaces, electronic appcessories, electronic tattoos, or smart watches).

In some embodiments of the present invention, the electronic device may be a smart home appliance having a broadcasting channel reception functionality. A smart home appliance may include, any of, for example, televisions, Digital Video Disc (DVD) players, audio systems, refrigerators, air conditioners, cleaning machines, ovens, microwaves, washing machines, air purifiers, set-top boxes, TV sets (e.g., SAMSUNG HOMESYNC™, APPLE TV™, or GOOGLE TV™), game consoles, electronic dictionaries, electronic keys, camcorders, and electronic albums.

In some embodiments of the present invention, the electronic device may include any of, for example, a variety of medical equipment (e.g., Magnetic Resonance Angiography (MRA), Magnetic Resonance Imaging (MRI), Computed Tomography (CT), photographing device, ultrasonic device, etc.), navigation devices, Global Positioning System (GPS) receivers, Event Data Recorders (EDRs), Flight Data Recorders (FDRs), car infotainment devices, marine electronic devices (e.g., marine navigation systems, gyro-compass, etc.), avionics, security devices, car head units, industrial or home robots, banking agency's Automatic Teller Machines (ATMs), or Point of Sales (POSs) for shops.

In some embodiments of the present invention, the electronic device may include any of, for example, furniture, a building, or a part of a structure including a broadcasting channel reception capability, electronic boards, electronic signature receiving devices, projectors, or various instrumental equipment (e.g., meters for water, electricity, gas, or radio waves).

An electronic device in accordance with various embodiments of the present invention may include one or more combinations of the aforementioned devices. In addition, the electronic device in accordance with various embodiments of the present invention may be a flexible device. The electronic device is not limited to the aforementioned examples.

An electronic device in accordance with various embodiments of the present invention is described as follows with reference to accompanying drawings. Herein, the term “user” may refer to a person who uses the electronic device or a device (e.g., an artificially intelligent device) that uses the electronic device.

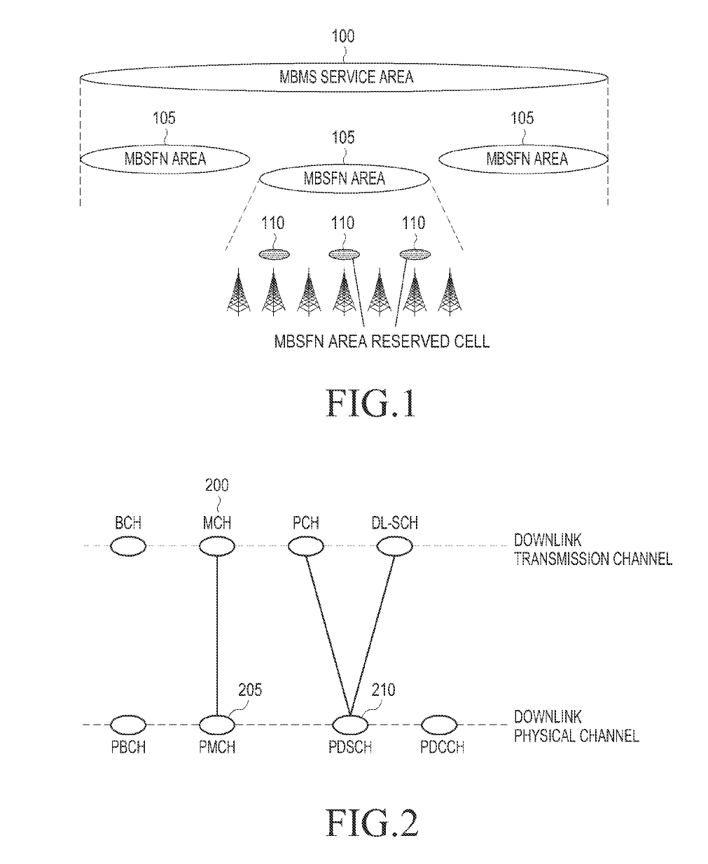

FIG. 1 is a diagram illustrating a concept of a Multimedia Broadcast and Multicast Service (MBMS) system according to an embodiment of the present invention.

Referring to FIG. 1, an MBMS service area 100 is a network area that includes a number of eNode Bs that perform Multimedia Broadcast multicast service Single Frequency Network (MBSFN) transmission.

An MBSFN area 105 is a network area that includes a number of cells integrated for MBSFN transmission. All of the cells in the MBSFN area 105 are synchronized for MBSFN transmission.

All the cells except for MBSFN area reserved cells 110 may be used in MBSFN transmission. The MBSFN area reserved cells 110 not used in the MBSFN transmission may be used in transmission for other purposes, but allow limited transmit power for radio resources allocated for MBSFN transmission.

FIG. 2 is a diagram illustrating downlink channel mapping relations used in MBSFN transmission according to an embodiment of the present invention.

Referring to FIG. 2, a Multicast Channel (MCH) 200 is used between a Medium Access Channel (MAC) layer and a physical layer, and may be mapped to a Physical Multicast Channel (PMCH) 205 of the physical layer.

A unicast method that transmits data only to a particular electronic device may commonly employ a Physical Downlink Shared Channel (PDSCH) 210.

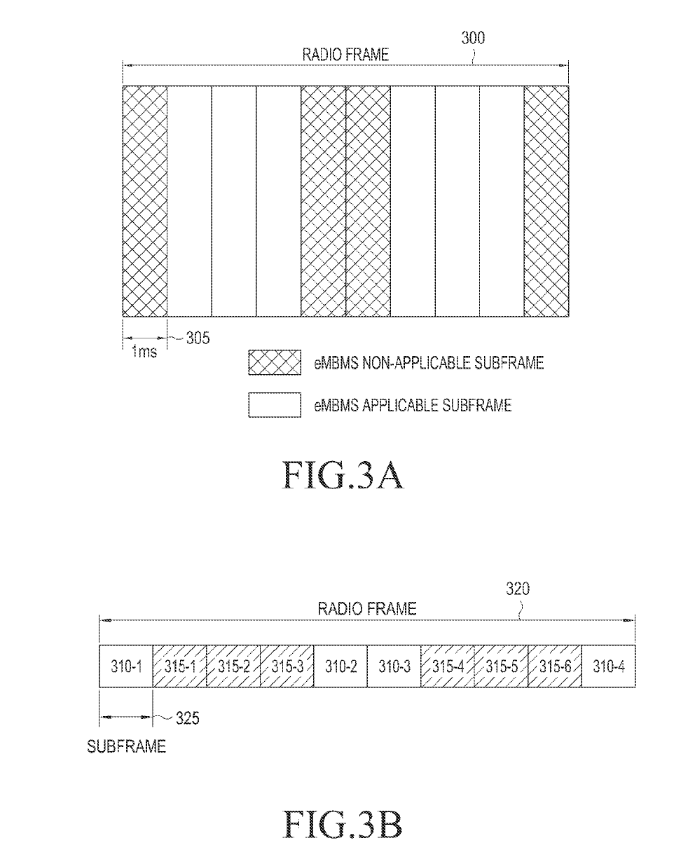

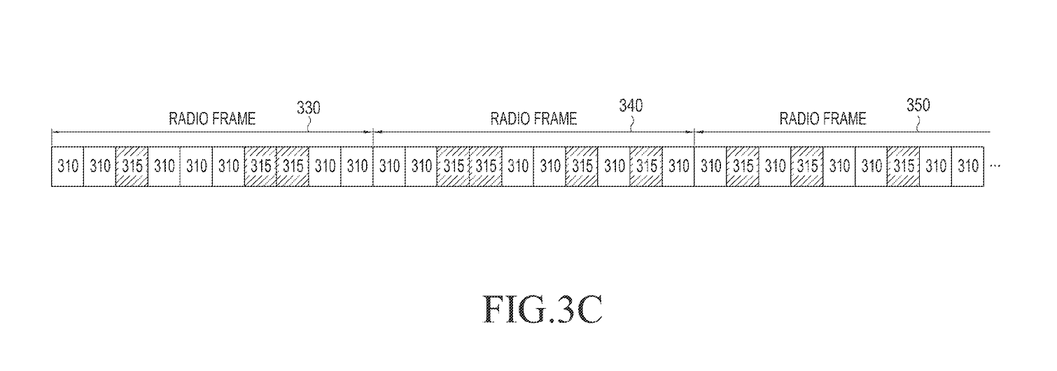

FIGS. 3A and 3B are diagrams illustrating downlink frame structures used in a Long Term Evolution (LTE) system according to an embodiment of the present invention.

Referring to FIG. 3A, a radio frame 300 includes 10 subframes 305. Some subframes among the subframes 305 of the radio frame 300 may not be applied to an evolved Multimedia Broadcast and Multicast Service (eMBMS). For example, as shown in FIG. 3A, first, fifth, sixth, and tenth subframes of the radio frame 300 may not be applied to the eMBMS. Also, in the LTE system, each subframe 305 may have a unit of 1 ms. In another embodiment of a system that uses different communication, the subframe 305 may have a unit value other than 1 ms.

Although in the example of FIG. 3A, the radio frame 300 includes 10 subframes 305, other amounts of subframes may be included a radio frame in accordance with embodiments of the present invention. FIG. 3B shows another type of radio frame 320. Referring to FIG. 3B, the radio frame 320 includes 10 subframes 325. Among the 10 subframes 325, some subframes 310-1, 310-2, 310-3, and 310-4 are used as unicast subframes and some subframes 315-1, 315-2, 315-3, 315-4, 315-5, and 315-6 are used as MBSFN subframes. FIG. 3C shows successive radio frames 330, 340, and 350. Here, subframes are classified into common subframes 310 used for common data communications and MBSFN subframes 315 used for broadcasting.

The common subframes and MBSFN subframes differ in their respective structures and numbers of Orthogonal Frequency Division Multiplexing (OFDM) symbols, the lengths of cyclic prefixes, Cell-specific Reference Signals (CRSs), etc.

In RELease-8 (Rel-8) or RELease-9 (Rel-9) systems, the MBSFN subframes were only used for sending broadcast or multicast data. However, in more evolved systems including LTE Rel-10, the MBSFN subframes may be used, not only for broadcasting or multicasting, but also for unicasting.

LTE systems divide and set electronic devices by Transmission Mode™ related to antenna technologies and Reference Signals (RS) to efficiently use a Physical Downlink Shared CHannel (PDSCH).

Transmission Modes (TMs) TM1 to TM9 are included in the current LTE Rel-10. Each electronic device has one TM for PDSCH transmission, and TM 8 and TM 9 were newly defined in Rel-9 and Rel-10, respectively.

In particular, TM 9 may support Single User Multi-Input Multi-Output (SU-MIMO) that has up to 8 ranks. TM 9 enables transmission of up to 8 layers by supporting multi-layer transmission and using Rel-10 Demodulation Reference Signal (DMRS) in demodulation. With respect to the Rel-10 DMRS, a precoded DMRS is transmitted but there is no need to inform a receiving end of a corresponding precoder index. Furthermore, to support TM 9, Downlink Control Information (DCI) format 2C is newly defined in Rel-10. It is notable that electronic devices before Rel-10 do not attempt decoding in the MBSFN subframes. Thus, having all electronic devices attempt decoding in the MBSFN subframes leads to a demand to upgrade the electronic devices before Rel-10.

The MBSFN may obtain resource allocation information through the following procedure. First, an eNode B informs an electronic device of a transmission location of a Multicast Control Channel (MCCH) for each MBSFN area that a cell provides, through System Information Block 13, which is broadcast information. An MCCH includes resource allocation information for MBSFN, and the electronic device is able to determine the transmission location of the MBSFN subframe by decoding the MCCH.

According to an embodiment of the present invention, content data related to each broadcast may be transmitted in each MBSFN subframe. This form of transmission is described in more detail herein with reference to FIG. 3B.

For example, as shown in FIG. 3B, content data for A broadcasting is transmitted in subframes 315-1, 315-2, and 315-3, and content data for B broadcasting is transmitted in subframes 315-4, 315-5, and 315-6. The MBSFN subframe pattern of the content data may be changed in the next radio frame. For example, in contrast to the previously transmitted radio frame, in another radio frame, content data for A broadcasting may be transmitted in subframes 315-4, 315-5, and 315-6, and content data for B broadcasting may be transmitted in subframes 315-1, 315-2, and 315-3.

According to an embodiment of the present invention, content data in relation to currently viewed broadcasting may be allocated in multiple MBSFN subframes. For example, content data for A broadcasting currently being viewed, may be transmitted in subframes 315-1, 315-2, 315-3, 315-4, and 315-5 and content data for B broadcasting may be transmitted in subframe 315-6. The MBSFN subframe pattern of the content data may be changed in the next radio frame. For example, content data for A broadcasting currently being viewed, may be transmitted in subframes 315-1, 315-3, 315-4, 315-5, and 315-6 and content data for B broadcasting may be transmitted in the subframe 315-2.

According to an embodiment of the present invention, content data in relation to different broadcasts may be concurrently transmitted in a single MBSFN subframe. For example, content data for A and B broadcasts may be transmitted in subframe 315-1.

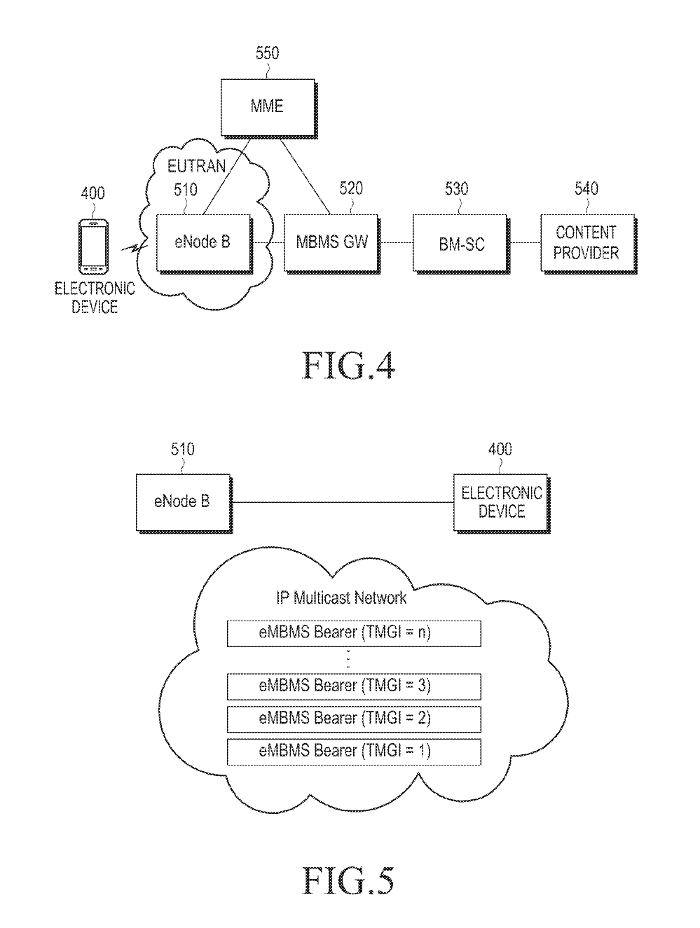

FIG. 4 is a block diagram illustrating an arrangement of a broadcasting service network, according to an embodiment of the present invention.

The broadcasting service network shown in FIG. 4 is an eMBMS-based broadcasting service network. Although the following description refers to an eMBMS-based broadcasting service as an example, embodiments of the present invention may be applied to any type of digital broadcasting service. For example, the embodiments of the present invention may be applied to Digital Video Broadcasting (DVB) services, Digital Multimedia Broadcasting (DMB) services, Internet Protocol Television (IP TV) services, etc.

Referring to FIG. 4, an eMBMS-based broadcasting service network may include an Evolved Universal Mobile Telecommunications Network Terrestrial Radio Access Network (EUTRAN) that includes at least one eNode B 510 for performing wireless communication with an electronic device 400, an Mobility Management Entity (MME) 550, an MBMS gateway 520 responsible for traffic transmission/reception to/from an outside of the network, and a Broadcast Multicast Service Center (BM-SC) 530 for providing an eMBMS service.

Elements of the network, such as those described above, may simultaneously deliver multimedia content to multiple electronic devices 400 at a designated point in time through single transmission, by performing session management, bearer setting and management for delivering content received from a content provider 540.

The electronic device 400 may receive content data provided from a broadcasting service network.

The eNode B 510 included in the EUTRAN may receive uplink signals sent from the electronic device 400 at a physical level, and transmit downlink signals to the electronic device 400. More specifically, eNode B 510 exchanges signals with the electronic device 400, and serves as an Access Point (AP) of the electronic device 400. The eNode B 510 communicates with the electronic device 400 that exists in the corresponding cell by managing radio resources per cell.

The MME 550 provides session control over an MBMS bearer for EUTRAN access. The MME 550 receives an MBMS service control message and IP multicast address for MBMS data reception, from the MBMS gateway device 520. Furthermore, the MME 550 transmits session control messages to multiple eNode Bs. The MBMS gateway device 520 functionally provides transmission and broadcasting of the content data to an eNode B that transmits a related service. The MBMS gateway device 520 performs session control in a mobile communication network to support eMBMS services. The MBMS gateway device 520 performs MBMS session control signaling for the UTRAN through the MME 550. Also, the MBMS gateway device 520 manages an MBMS traffic pass and delivers the traffic through the pass. In other words, the MBMS gateway device 520 sets up an MBMS bearer for the eMBMS service in association with the eNode B 510 of the EURAN or through the MME 550, and provides a content transmission function through the MBMS bearer.

The BM-SC 530 is a node responsible for controlling eMBMS services and exists as a functional element in the LTE system to provide the eMBMS service. The BM-SC 530 becomes a main entity for management and control over the eMBMS service, hosting an MBMS session start procedure or an MBMS session stop procedure to manage the commencement and termination of all broadcast or multicast types of eMBMS service. In this regard, the eNode B 510 performs an eMBMS bearer setup procedure for content delivery, and each bearer is set up to use resources based on bearer transmission capacity, Quality of Service (QoS) information, etc., depending on content properties. In addition, when using a multicast service, a multicast tree may be configured to deliver data that the service intends to deliver by receiving multicast joins from the electronic device 400. Configuration of the multicast tree may be performed in an MBMS activation procedure. In the MBMS activation procedure, a registration procedure to register a pass connecting an upper node to a corresponding electronic device is performed such that the pass goes through lower nodes, and the BM-SC 530, MBMS gateway 520, MME 550, eNode B 510, electronic device 400 may each generate a bearer context for the eMBMS service.

FIG. 5 is a diagram illustrating communications between the eNode B 510 and the electronic device 400, according to an embodiment of the present invention.

Referring to FIG. 5, communication between the eNode B 510 and the electronic device 400 are carried out based on an IP multicast network. Each eMBMS bearer transmits at least one service and is identified by a Temporary Mobile Group Identity (TMGI). When using a broadcasting service, for example, an eMBMS bearer corresponds to a broadcasting channel, and a number of broadcasting channels may be identified by their respective TMGIs. To receive a broadcasting channel provided by an eMBMS based broadcasting service, the electronic device 400 accesses an eMBMS bearer corresponding to the broadcasting channel and then receive multimedia content packet data.

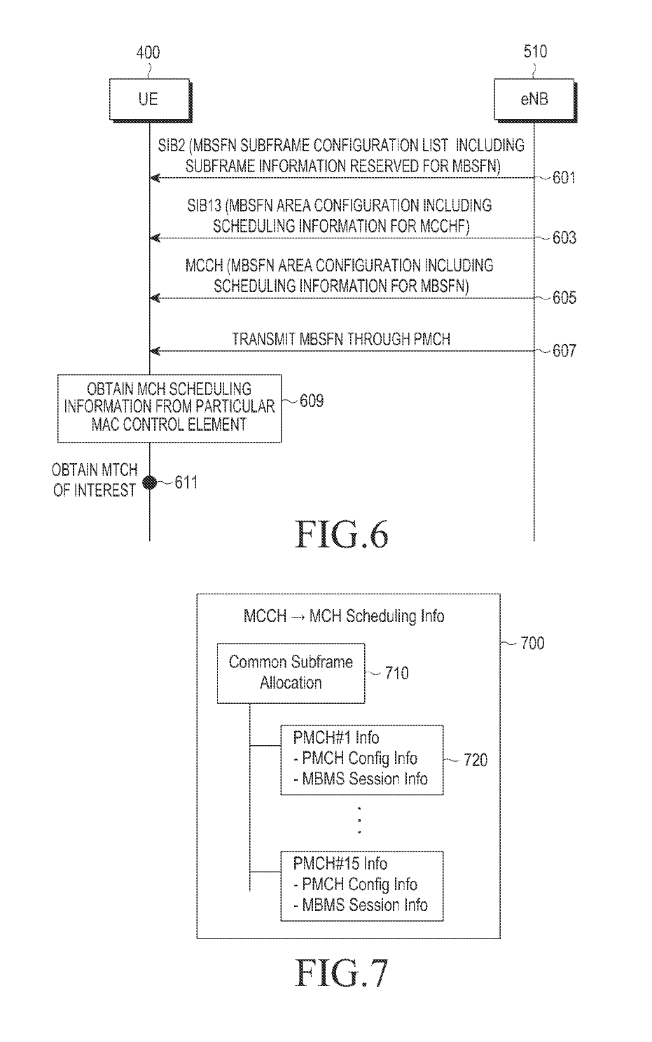

FIG. 6 is a diagram illustrating a method of MBSFN reception of an electronic device according to an embodiment of the present invention.

Referring to FIG. 6, the electronic device 400 receives SIB2 from the eNode B 510, in step 601. An MBSFN subframe configuration list (MBSFN-SubframeConfigList IE) of the SIB2 indicates subframes that may be used for MBSFN transmission. The MBSFN-SubframeConfigList Information Element (IE) includes MBSFN-SubframeConfig IE, indicating which subframe(s) of which radio frame may become MBSFN subframe(s). Table 1 represents configurations of the MBSFNSubframeConfig IE.

TABLE 1

-- ASN1START
MBSFN-SubframeConfig ::= SEQUENCE {
radioframeAllocationPeriod ENUMERATED {n1, n2, n4, n8, n16,
n32},
radioframeAllocationOffset INTEGER (0..7),
subframeAllocation CHOICE {
oneFrame BIT STRING
(SIZE(6)),
fourFrames BIT STRING
(SIZE(24))
}
}
-- ASN1STOP

Here, a radio frame allocation period (radioFrameAllocationPeriod) and radio frame allocation offset (radioFrameAllocationOffset) are used to indicate a radio frame that has the MBSFN subframe, and a radio frame that that satisfies the equation, SFN mod radioFrameAllocationPeriod=radioFrameAllocationOffset, has the MBSFN subframe.

System Frame Number (SFN) indicates a radio frame number. The SFN has a value in the range of 0 to 1023 and may be repeated. Subframe allocation (subframeAllocation) indicates which subframe is an MBSFN subframe in the radio frame indicated by the equation. The subframe allocation may be indicated in a single radio frame unit or four radio frame units. When a single radio frame unit is used, the subframe allocation is indicated in oneFrame IE. The MBSFN subframe may exist among 1st, 2nd, 3rd, 6th, 7th, and 8th subframes of a total of 10 subframes in a single radio frame. Thus, oneFrame IE may indicate the MBSFN subframe among the enumerated subframes in 6 bits. When four radio frame units are used to indicate the subframe allocation, the subframe allocation is indicated in fourFrames IE. To cover the four radio frames, a total of 24 bits are used to indicate MBSFN subframes among the enumerated subframes for the radio frames. Accordingly, the electronic device 400 may use the MBSFN-SubframeConfigList IE to accurately find subframes that may be MBSFN subframes.

For MBSFN reception, the electronic device 400 receives System Information Block (SIB)13 from the eNode B 510, in step 603. An MBSFN area information list (MBSFN-AreaInfoList IE) of the SIB13 includes information about a location to which an MCCH per MBSFN area provided by a cell is sent, and the electronic device 400 may use this information to receive the MCCH, in step 605.

MBSFN area configuration information (MBSFNAreaConfiguration IE) of the MCCH indicates a location of a resource used for MBSFN transmission, and the electronic device 400 uses this information to receive MBSFN subframes in step 607. In step 609, the electronic device 400 obtains the location of an MBSFN subframe in which a desired Multicast Traffic Channel (MTCH) is transmitted, from MCH scheduling information MAC Control Element (CE), which is one of MAC control elements (MACCEs) of the received MAC Packet Data Unit (PDU). In step 611, the electronic device 400 uses the MCH scheduling information (MCHscheduling information) to decode the desired MTCH.

FIG. 7 is a diagram illustrating an example of MCH scheduling information according to an embodiment of the present invention.

Referring to FIG. 7, the MCH scheduling information 700 includes common subframe allocation information 710, and PMCH information 720 for each PMCH. Each PMCH information 720 includes PMCH configuration information and MBMS session information. The MBMS session information includes service guide information. The service guide information is information regarding a guide to broadcasting content provided from the broadcasting service, including channel information and program information provided by each channel. For example, the program information may include a start and stop time of each program, a content type information for each program, title information, etc.

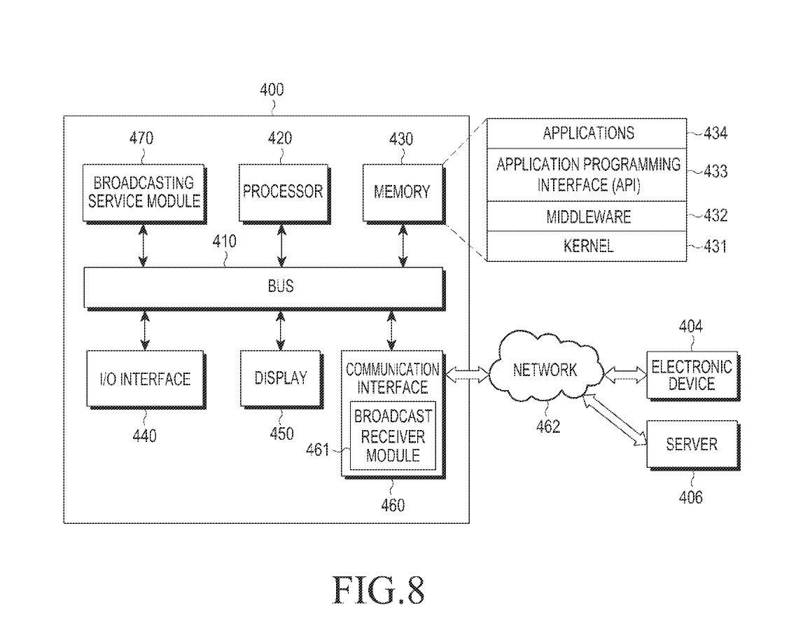

FIG. 8 is a diagram illustrating a network environment including an electronic device, according to an embodiment of the present invention.

Referring to FIG. 8, the electronic device 400 includes a bus 410, a processor 420, a memory 430, an Input/Output (I/O) interface 440, a display 450, a communication interface 460, and a broadcasting service module 470.

The bus 410 includes circuitry for interconnecting the enumerated components and delivering communications (e.g., control messages) among the connected components.

The processor 420 receives requests or commands from the enumerated components, the memory 430, the I/O interface 440, the display 450, the communication interface 460, or the broadcasting service module 470 via the bus 410, interprets the requests or commands, and performs an operation or data processing according to the interpreted request or command.

The memory 430 stores requests, commands, or data received or generated from the enumerated components (e.g., the processor 420, the I/O interface 440, the display 450, the communication interface 460, the broadcasting service module 470, etc.). The memory 430 includes, for example, programming modules, such as kernel 431, middleware 432, Application Programming Interface (API) 433, application 434, etc. Each of the programming modules may be implemented in software, firmware, hardware, or a combination thereof. For example, the broadcasting service module 470 may include software, such that at least a portion of the software is executed by the processor 420.

The kernel 431 controls or manages system resources (e.g., the bus 410, the processor 420, the memory 430, etc.) to be used to carry out an operation or function implemented by the other programming modules (e.g., the middleware 432, the API 433, or the application 434). Furthermore, the kernel 431 provides an interface for the middleware 432, the API 433, or the application 434 to access respective components of the electronic device 400 to control or manage them.

The middleware 432 acts as an intermediary for the API 433 or the application 434 to communicate data with the kernel 431. In addition, the middleware 432 performs control operations (e.g., scheduling or load balancing) in response to a task request received from the application 434 by, for example, placing a high priority on at least one application included in the application 434 to use system resources (e.g., the bus 410, the processor 420, the memory 430, etc.) of the electronic device 400.

The API 433 is an interface for the application 434 to control a function provided from the kernel 431 or the middleware 432, and may include at least one interface or function (e.g., an instruction) for e.g., file control, window control, image processing, text control, etc.

In accordance with various embodiments of the present invention, the application 434 may include (not shown) a Short Message Service (SMS)/Multimedia Message Service (MMS) application, an email application, a calendar application, an alarm application, a healthcare application (e.g., an application for measuring quantity of motion or blood sugar), or environmental information application (e.g., an application for providing atmospheric pressure, humidity, or temperature). The application 434 may be an application involved in information exchange between the electronic device 400 and an external electronic device 404. The application involved in such information exchange may include, for example, a notification relay application for relaying particular information to the external electronic device 404 or a device management application for managing the external electronic device 404.

For example, the notification relay application may include functionality for notifying the external electronic device 404 of notification information generated in any other application (e.g., the SMS/MMS application, the email application, the healthcare application, or the environmental information application) of the electronic device 400. Additionally or alternatively, the notification relay application may, for example, receive the notification information from the external electronic device 404 and provide the notification information to the user. The device manager application may manage (e.g., install, delete or update) a function (e.g., turning on/off the external electronic device 404 itself or a part of the external electronic device 404, or controlling display brightness of the external electronic device 404) with respect to part of the external electronic device 404 in communication with the electronic device 400, or a service (e.g., calling or messaging service) provided by the external electronic device 404 or an application running in the external electronic device 404.

In accordance with various embodiments of the present invention, the application 434 may include an application designated according to an attribute of the electronic device 404 (e.g., according to a type of the electronic device 404). For example, when the external electronic device 404 is an MP3 player, the application 434 may include an application related to music playback. Similarly, when the external electronic device 404 is a mobile medical device, the application 434 may include an application related to healthcare. In accordance with an embodiment of the present invention, the application 434 includes at least one of an application dedicated to the electronic device 400, and an application received from the external electronic device 404 or a server 406.

The I/O interface 440 delivers instructions or data entered by the user through the I/O device (e.g., a sensor, a keyboard, or a touch screen) to the processor 420, the memory 430, the communication interface 460, or the broadcasting service module 470 via the bus 410. For example, the I/O interface 440 may provide data for a user touch input through the touch screen to the processor 420. The I/O interface 440 may also output a command or data received from the processor 420, the memory 430, the communication interface 460, or the broadcasting service module 470 via the bus 410 through the I/O device (e.g., a speaker or display). For example, the I/O interface 440 may output audio data processed by the processor 420 to the user.

The display 450 displays various information (e.g., multimedia data or text data) for the user.

The communication interface 460 connects communication between the electronic device 400 and the external electronic device 404 or the server 406. For example, the communication interface 460 may be connected to a network 462 through wired or wireless communication and communicates with the external electronic device 404 or the server 406. The wireless communication may include at least one of Wi-Fi, Bluetooth (BT), Near Field Communication (NFC), Global Positioning System (GPS), or cellular communication (e.g., LTE, LTE-Advanced (LTE-A), Code Division Multiple Access (CDMA), Wideband-CDMA (WCDMA), Universal Mobile Telecommunication System (UMTS), Wireless BROadband (Wibro) or Global System for Mobile communications (GSM)). The wired communication may include, for example, any of Universal Serial Bus (USB), High Definition Multimedia Interface (HDMI), Recommended Standard (RS) 232 or Plain Old Telephone Service (POTS).

The communication interface 460 includes a broadcast receiver module 461. The broadcast receiver module 461 receives content data from a broadcasting service network (e.g., as shown in FIG. 1) under control of the broadcasting service module 470. According to an embodiment of the present invention, the content data may include multimedia data (e.g., videos, still images, picture files, photos, or audio) or text data. According to an embodiment of the present invention, at least a part of the content data may be received in a form of a packet.

The received content data is delivered to the broadcasting service module 470 via the bus 410. In various embodiments of the present invention, under control of the broadcasting service module 470, the broadcast receive module 461 may access multiple broadcasting channels (e.g., eMBMS bearers) simultaneously, receive content data of each broadcasting channel, and deliver the content data to the broadcasting service module 470 via the bus 410.

In accordance with an embodiment of the present invention, the network 462 may be a telecommunications network. The telecommunications network may include at least one of computer network, Internet, Internet of things, or telephone network.

In accordance with an embodiment of the present invention, a protocol (e.g., a transport layer protocol, a data link layer protocol or a physical layer protocol) for communication between the electronic device 400 and the external device 404 or the server 406 may be supported by at least one of the application 434, the API 433, the middleware 432, the kernel 431 or the communication interface 460.

The broadcasting service module 470 handles at least a part of information obtained from other components (e.g., the processor 420, the memory 430, the I/O interface 440, or the communication interface 460) and provides the results to the user in various ways. For example, the broadcasting service module 470 may enable image data to be displayed in the display 450 or audio data to be output through the I/O interface 440, by processing and reproducing the content data delivered from the broadcast receiver module 461, in combination with or separately from the processor 420. In other words, the broadcasting service module 470 enables content data to be received on a broadcasting channel requested for play, processes the received content packet data, and enables the requested broadcasting channel to be output to the user.

The broadcasting service module 470 may be hardware, according to an embodiment of the present invention. The broadcasting service module 470 may be software, which may be executed by the processor 420, according to an embodiment of the present invention. The broadcasting service module 470 may be any of hardware, software, and firmware, or a combination thereof, according to an embodiment of the present invention.

According to various embodiments of the present invention, the broadcasting service module 470 enables simultaneous reception of content data of at least one candidate channel other than the broadcasting channel requested by the user to be played, through the broadcast receiver module 461. The candidate channel may be a broadcasting channel that has a possibility of being requested for play other than the output broadcasting channel. For example, the candidate channel may be a neighboring channel or the user's preferred channel. Specifically, the broadcasting service module 470 receives content data of a first broadcasting channel, and may receive content data of a second broadcasting channel while outputting part of the content data of the first broadcasting channel. The content data of the second broadcasting channel may be output with that of the first broadcasting channel concurrently or non-concurrently.

According to an embodiment of the present invention, if a predetermined condition, i.e., a candidate channel reception condition is met, the broadcasting service module 470 may access the candidate channel and receive corresponding content data.

The predetermined condition or the candidate channel reception condition may be, for example, a request to play the broadcasting channel. Specifically, if there is a request to play a broadcasting channel, access to the requested channel (e.g., the first broadcasting channel) and reception of the content data may be performed concurrently with access to a candidate channel (e.g., the second broadcasting channel) and reception of the corresponding content data.

According to an embodiment of the present invention, the predetermined condition may be a request for candidate channel reception directly input to the electronic device 400 or input from another electronic device operationally connected to the electronic device 400. According to an embodiment of the present invention, the request for a candidate channel reception may be a request to play a next channel or a previous channel with respect to the currently output broadcasting channel.

According to an embodiment of the present invention, the user's swiping gesture on the touch screen may generate a request for candidate channel reception. The candidate channel may be a previous channel or next channel to the currently output channel, depending on the swiping direction. According to another embodiment of the present invention, the user's voice command, such as “next channel” or “previous channel” input to the electronic device 400 may generate a reception request for the corresponding channel. Alternatively, when the user moves the electronic device 400 in one of up, down, left, and right directions, the reception request may occur for a broadcasting channel designated for the corresponding direction. Alternatively, when the user inputs a channel number other than the channel being viewed, reception for the channel may be requested. Alternatively, when the user stares at the screen of the electronic device 400 and then turns his/her face in any of up, down, left and right directions, a camera installed in the electronic device 400 may recognize the direction in which the user's face moves and a reception request for a broadcasting channel designated for the recognized direction may occur. Alternately, when a channel reception request is input from an external electronic device (e.g., a smart watch, a smart accessory, etc.) operationally connected to the electronic device 400, a reception request for the corresponding broadcasting channel may occur.

According to an embodiment of the present invention, the predetermined condition may be context information of at least one of the electronic device 400 and other electronic devices operationally connected to the electronic device 400. If conditions or surroundings of the electronic device 400 or other electronic devices operationally connected to the electronic device 400 correspond to the context information, content data corresponding to a candidate channel may be received automatically.

The context information may include information regarding the at least one device, including at least one of location, power status, communication status, time, weather, user schedule, broadcasting schedule, and a type of content data.

For example, when the at least one device is located at a set location, content data of a candidate channel may be received. Alternatively, when the power of the at least one device exceeds a threshold, content data of a candidate channel may be received. Alternatively, when the communication quality of the at least one device exceeds a threshold, content data of a candidate channel may be received.

For example, content data of a candidate channel may be received for a predetermined time or period. Alternatively, when the current weather corresponds to a predetermined weather condition, content data of a candidate channel may be received. Alternatively, whether to receive content data of a candidate channel may be determined according to the user schedule registered in the electronic device 400, i.e., at a point in time corresponding to the user schedule that allows reception of content data of a candidate channel, the content data of the candidate channel may be received. The user schedule may correspond to, for example, meeting, traveling, break time, TV watching, etc.

Alternatively, a determination of whether to receive content data of a candidate channel may be performed according to the broadcasting schedule information. For example, a determination of when to receive content data of a candidate channel may be performed based on the start or stop time of a broadcasting program corresponding to the content data being output. Alternatively, a determination of when to receive content data of a candidate channel may be performed based on a start time of the user's preferred broadcasting program.

In another embodiment of the present invention where the type of the content data being output is a designated content type, content data of a candidate channel may be received.

The content type refers to a classification basis, and may be e.g., a movie, advertisement, drama, sports, documentary, etc. Alternatively, if a type of the content provided on a broadcasting channel other than the broadcasting channel being played is a designated content type, content data of the corresponding broadcasting channel may be received.

According to an embodiment of the present invention, the broadcasting service module 470 may perform background processing on the content data of the received candidate channel not to disturb output of the requested broadcasting channel. For example, the broadcasting service module 470 may store the content data of the candidate channel for buffering in an encoded state. In another example, the broadcasting service module 470 may reproduced code and store the content data of the candidate channel in the background not to be actually displayed in the display 450. The broadcasting service module 470 may enable a candidate channel to be output to the user without delay due to the channel access and the content data reception, at the user's request to play the candidate channel, by performing background processing on the content packet data of the candidate channel.

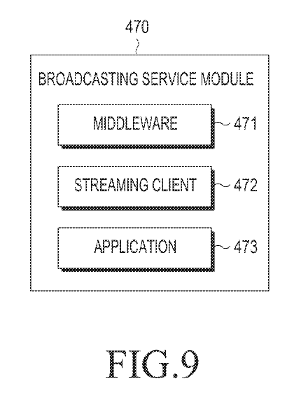

FIG. 9 is a diagram illustrating the broadcasting service module 470 of the electronic device 400, according to an embodiment of the present invention.

Referring to FIG. 9, the broadcasting service module 470 may include a middleware 471, a streaming client 472, and an application 473.

According to an embodiment of the present invention, the application 473 manages a user interface required to provide a broadcasting service. For example, the application 473 may provide the user interface through the I/O interface 440 (e.g., a touch screen).

The application also forwards a request input from the user through the I/O interface 440 to the middleware 471. The application controls image data and audio data delivered from the streaming client 472 to be output through the display 450 and a speaker.

According to an embodiment of the present invention, the middleware 471 plays an intermediary role of exchanging data between the broadcast receiver module 461 and the streaming client 472 or between the broadcast receiver module 461 and the application 473. The middleware 471 stores service guide information received through the broadcast receiver module 461. The middleware 471 provides the stored service guide information to the user through the application 473. The service guide information is information regarding a guide to broadcasting content provided from the broadcasting service, including channel information and program information provided by each channel. For example, the program information may include start and stop time of each program, content type information for each program, title information, etc. The middleware 471 performs control over the user request forwarded from the application 473. For example, at the user's request to play a channel, the middleware 471 may send a request for connection to the corresponding broadcasting channel to the broadcast receiver module 461 and in return, receive content data (e.g., multimedia data) from the broadcast receiver module 461. The middleware 471 delivers the content data to the streaming client 472. The middleware 471 serves as a streaming server for the streaming client 472. This middleware 471 may be, for example, an eMBMS middleware. According to an embodiment of the present invention, the middleware 471 may be located outside of the broadcasting service module 470.

The streaming client 472 decodes the content data received from the middleware 471 into an image format or an audio format suitable to stream out to the application 473. The streaming client 472 may be, for example, a Dynamic Adaptive Streaming over Hypertext Transfer Protocol (DASH HTTP) client.

According to various embodiments of the present invention, if a request to play a channel is received from the application 473, the middleware 471 may send a request for access to a requested broadcasting channel and at least one candidate channel to the broadcast receiver module 461. According to other embodiments of the present invention, the middleware 471 monitors whether a candidate channel condition is met, determines a candidate channel if the candidate channel condition is met, and sends a request for access to the candidate channel to the broadcast receiver module 461.

The broadcast receiver module 461 accesses a broadcasting channel requested for play or the candidate channel, upon a request by the middleware 471, receives respective content data of the requested broadcasting channel and the candidate channel, and forwards the content data to the middleware 471. According to an embodiment of the present invention, the content data may include multimedia data (e.g., videos, still images, picture files, photos, or audio) or text data. According to an embodiment of the present invention, the content data includes at least one of image data and audio data. According to an embodiment of the present invention, at least a part of the content data may be received in a form of a packet.

The middleware 471 forwards the content data of the requested broadcasting channel to the streaming client 472 to output the content data of the channel requested by the streaming client 472. The middleware 471 may perform background processing on the content data of the received candidate channel not to disturb output of the content data of the requested broadcasting channel.

For example, the middleware 471 may buffer the content data of the candidate channel. The buffered content data may not be in a decoded state. Then, at the user request, the middleware 471 may forward the buffered content data of the candidate channel to the streaming client 472 to output the candidate channel.

In another example, the middleware 471 may forward the content data of the candidate channel to the streaming client 472, and request the application 473 to reproduce the content data of the candidate channel in the background without actually being output. Accordingly, the streaming client 472 may decode the content data of the candidate channel and send the decoded content data to the application 473. The application 473 may store the decoded content in the memory 430 for buffering without outputting the decoded content data to the display 450.

The content data of the candidate channel may include at least one of image data and audio data. If the content data of the candidate channel includes both audio data and image data, the streaming client 472 may decode the content data into the audio data or image data and send the decoded image data or audio data to the application 473. The application 473 may store the decoded image data or audio data for buffering without outputting the decoded image data or audio data to the display 450. The image data may include video data or still image data (e.g., photos and pictures).

Then, upon reception of the candidate channel play request from the application 473, the middleware 471 may request the application 473 to output the candidate channel. Accordingly, the application 473 enables the content data of the candidate channel being buffered, e.g., image data and audio data, to be output to the display 450.

According to an embodiment of the present invention, the electronic device 400 may include a memory for storing content data and a broadcasting service module operationally coupled to the memory, and the broadcasting service module may be configured to receive first content data of a first broadcasting channel, output at least a part of the first content data to a display operationally coupled to the electronic device 400, and receive second content data of a second broadcasting channel at least temporarily while the at least a part of the first content data is being output.

According to an embodiment of the present invention, in the broadcasting service module, receiving the first content includes receiving a frame having multiple subframes, wherein the first content is included in one or more subframes exclusive of the first and last subframes in the frame; and receiving the second content includes receiving the frame, wherein the second content is included in subframes other than the first and last subframes and the one or more subframes in the frame.

According to an embodiment of the present invention, the broadcasting service module may be configured to store the second content data in the memory in an encoded state.

According to an embodiment of the present invention, the broadcasting service module may be configured to decode the encoded second content data stored in the memory and output the decoded second content based on an output request for the second broadcasting channel.

According to an embodiment of the present invention, the broadcasting service module may be configured to store the second content data in the memory in a decoded state.

According to an embodiment of the present invention, the broadcasting service module may be configured to output the decoded second content data stored in the memory based on a play request for the second broadcasting channel.

According to an embodiment of the present invention, the broadcasting service module may be configured to receive at least one content data corresponding to at least one additional broadcasting channel based on a request for the second broadcasting channel.

According to an embodiment of the present invention, the broadcasting service module may be configured to at least pause receiving or storing the second content data if there has been no request to play the second broadcasting channel for a predetermined time.

According to an embodiment of the present invention, the broadcasting service module may be configured to automatically determine the second broadcasting channel based on context information regarding at least one of the electronic device 400 and other devices operationally connected to the electronic device 400.

According to an embodiment of the present invention, the context information may include information regarding the at least one device, including at least one of a location of at least one of the at least one device, a power status of at least one of the at least one device, a communication status of at least one of the at least one device, a current time, weather at the location of at least one of the at least one device, a broadcasting schedule, a user schedule, and a content type of the first content data.

According to an embodiment of the present invention, the first content data and the second content data may be received using the same communication method.

According to an embodiment of the present invention, the first content data and the second content data may be received using different communication methods.

According to an embodiment of the present invention, the first content data and the second content data may be received from different communication networks.

According to an embodiment of the present invention, the first content data may be received from an LTE network while the second content data is received from a Wi-Fi network.

According to an embodiment of the present invention, at least a part of the second content data may be output concurrently with at least a part of the first content data.

According to an embodiment of the present invention, concurrent output of the at least a part of the second content data and the at least a part of the first content data may be avoided.

According to an embodiment of the present invention, at least one of the first content data and the second content data may be received in a form of a packet.

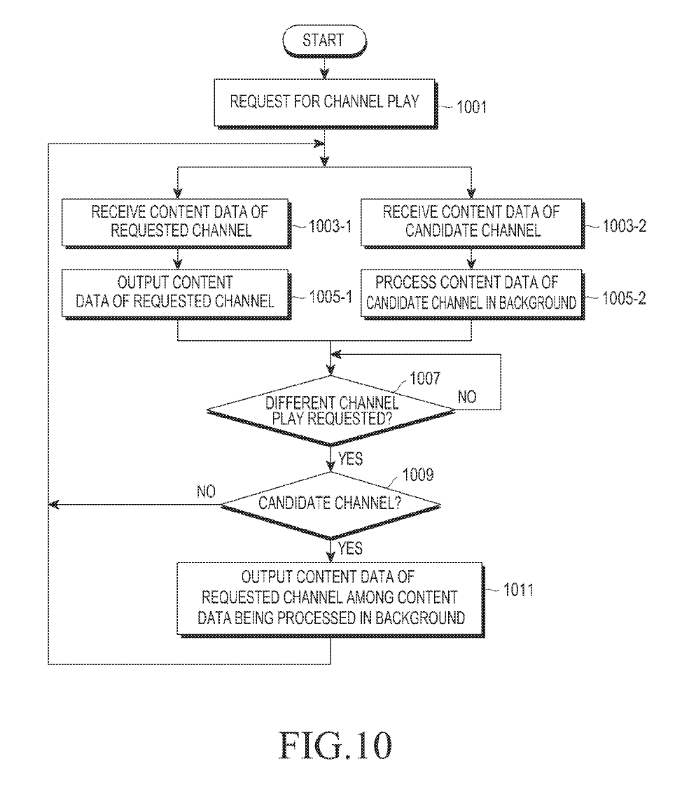

Operations of the electronic device 400 are described as follows with reference to FIG. 10.

FIG. 10 is a flowchart illustrating operations of an electronic device according to an embodiment of the present invention.

In the embodiment of FIG. 10, a request to play a broadcasting channel is set as a candidate channel reception condition.

Referring to FIG. 10, when there is a request to play a channel selected by the user through the I/O interface 400, in step 1001, the broadcasting service module 470 of the electronic device 400 sends a request for connection to the requested broadcasting channel and a candidate channel to the broadcast receiver module 461.

The candidate channel may include, for example, n broadcasting channels before the requested broadcasting channel. Alternatively, the candidate channel may include m broadcasting channels after the requested broadcasting channel. Alternatively, the candidate channel may include n broadcasting channels before the requested broadcasting channel and m broadcasting channels after the requested broadcasting channel. Alternatively, the candidate channel may include all available broadcasting channels except for the requested broadcasting channel. Alternatively, the candidate channel may be the user's preferred channel registered in advance. Alternatively, the candidate channel may be a broadcasting channel that provides the user's preferred program registered in advance. Alternatively, the candidate channel may include n broadcasting channels that have been frequently viewed, based on the user's channel view history.

Upon a request from the broadcasting service module 470, the broadcast receiver module 461 may access the requested broadcasting channel and candidate channel, receive respective content data of the channels, and forward the content data to the broadcasting service module 470.

Accordingly, the broadcasting service module 470 receives content data of the requested broadcasting channel in step 1003-1, and receives content data of the candidate channel in step 1003-2.

The broadcasting service module 470 allows the broadcasting channel requested by the user to be viewed by outputting content data of the requested broadcasting channel, in step 1005-1. The broadcasting service module 470 also performs background processing on the content data of the candidate channel, in step 1005-2.

While viewing the requested broadcasting channel, the user may input, to the electronic device 400, a request to play a channel other than the currently-viewed broadcasting channel. For example, if the user makes a swiping gesture on the touch screen, a request to play a previous channel or next channel in sequence from the currently viewed channel may occur depending on the swiping direction. According to another embodiment of the present invention, if the user inputs a voice command, such as “next channel” or “previous channel”, to the electronic device 400, a request to play the corresponding channel may occur. Alternatively, when the user moves the electronic device 400 in one of up, down, left, and right directions, a request to play a broadcasting channel designated for the corresponding direction may occur. Alternatively, when the user inputs another channel number different from the channel being viewed, play for the corresponding channel may be requested. Alternatively, when the user stares at the screen of the electronic device 400 and then turns his/her face in any of up, down, left and right directions, a camera installed in the electronic device 400 may recognize the direction in which the user's face moves and a request to play a broadcasting channel designated for the recognized direction may occur. Alternately, when a channel change request is input from an external electronic device (e.g., a smart watch, a smart accessory, etc.) operationally connected to the electronic device 400, a request to play the corresponding broadcasting channel may occur. The channel change request from the external electronic device may occur in response to a voice command input from the external electronic device, a gesture recognized through the camera, or a gesture input by the user.

When requested from the I/O interface 440 to play a different channel, in step 1007, the broadcasting service module 470 determines whether the different channel is one of candidate channels, in step 1009.

If the different channel is not a candidate channel, the broadcasting service module 470 proceeds to steps 1003-1 and 1003-2 to access a newly requested channel and candidate channel.

However, if it is determined in step 1009 that the different channel is a candidate channel, the broadcasting service module 470 outputs content data of the different channel (i.e., a channel requested by the user) among content data being processed in the background, in step 1011.

Accordingly, the broadcasting service module 470 outputs the channel requested by the user without delay due to the channel access.

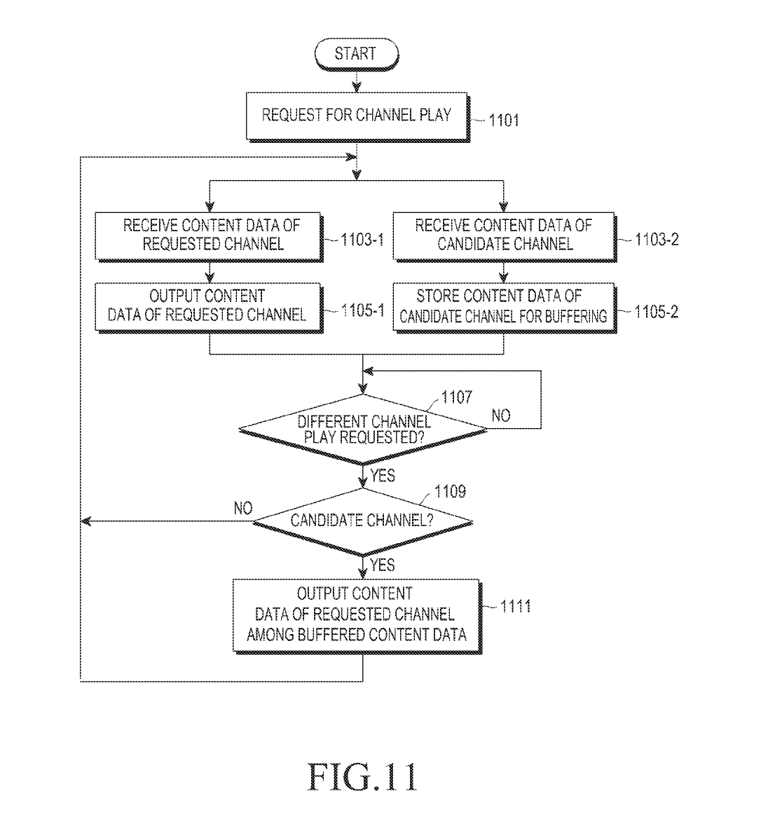

Various embodiments of processing a candidate channel in the background according to an embodiment of the present invention are described as follows with reference to FIGS. 11 to 15, FIGS. 16A and 16B.

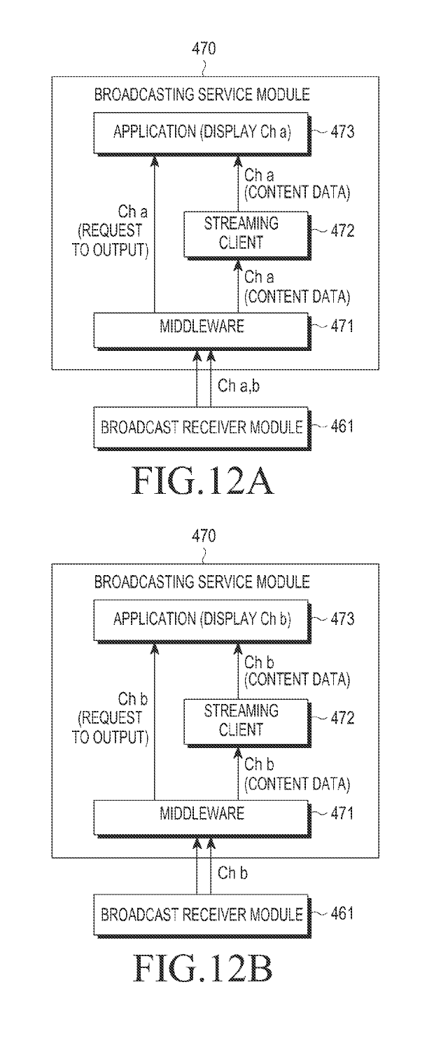

FIG. 11 is a flowchart illustrating operations of an electronic device, according to another embodiment of the present invention. FIG. 12 is a diagram illustrating a procedure of processing a broadcasting channel, according to an embodiment of the present invention.

More specifically FIG. 11 illustrates a procedure of processing a broadcasting channel. FIG. 12A illustrates processing of a broadcasting channel corresponding to steps 1103-1, 1103-2, 1105-1, and 1105-2 of FIG. 11.

In the embodiment of FIG. 11, a request to play a broadcasting channel is set as a candidate channel reception condition.

Referring to FIG. 11, when the user requests to play a selected channel through the I/O interface 400, in step 1101, the broadcasting service module 470 of the electronic device 400 sends a request to access the requested broadcasting channel and a candidate channel to the broadcast receiver module 461.

Upon a request from the broadcasting service module 470, the broadcast receiver module 461 accesses the requested broadcasting channel and candidate channel, receives respective content data of the channels, and forwards the content data to the broadcasting service module 470.

Accordingly, the broadcasting service module 470 receives content data of the requested broadcasting channel in step 1103-1, and receives content data of the candidate channel in step 1103-2.

The broadcasting service module 470 allows the user to view the broadcasting channel requested by the user by outputting the content data of the requested broadcasting channel, in step 1105-1. The broadcasting service module 470 also stores the content data of the candidate channel for buffering, in step 1105-2.

For example, assuming that a broadcasting channel selected by the user is Ch a and a candidate channel is Ch b, referring to FIG. 12A, content data of Ch a and content data of Ch b received by the broadcast receiver module 461 may be sent to the middleware 471 of the broadcasting service module 470.

The middleware 471 forwards the content data of Ch a to the streaming client 472 and sends a request for output for Ch a to the application 473. The middleware 471 may store the content data of Ch b for buffering.

The streaming client 472 decodes the content data of Ch a into image data and audio data. The streaming client 472 also reproduces and sends the image data and audio data to the application 473 to output content of Ch a.

Accordingly, the user may view a requested broadcasting channel, i.e., Ch a. While viewing the requested broadcasting channel, the user may input a request to play a different channel from the broadcasting channel to the electronic device 400.

When the user request to play a different channel is input, in step 1007, the broadcasting service module 470 determines whether the different channel is one of candidate channels, in step 1109.

If the different channel is not a candidate channel, the broadcasting service module 470 proceeds to steps 1103-1 and 1103-2 to access a newly requested channel and candidate channel.

Otherwise, if it is determined in step 1109 that the different channel is a candidate channel, the broadcasting service module 470 decodes, and outputs content data of the different channel, i.e., a channel requested by the user, among buffered content data in step 1111. Accordingly, the broadcasting service module 470 outputs the channel requested by the user without delay due to the channel access.

Referring to FIG. 12B, if the different channel is Ch b, the middleware 471 of the broadcasting service module 470 delivers the content data of Ch b, which is being buffered, to the streaming client 472 to output Ch b to the user without delay of access to Ch b.

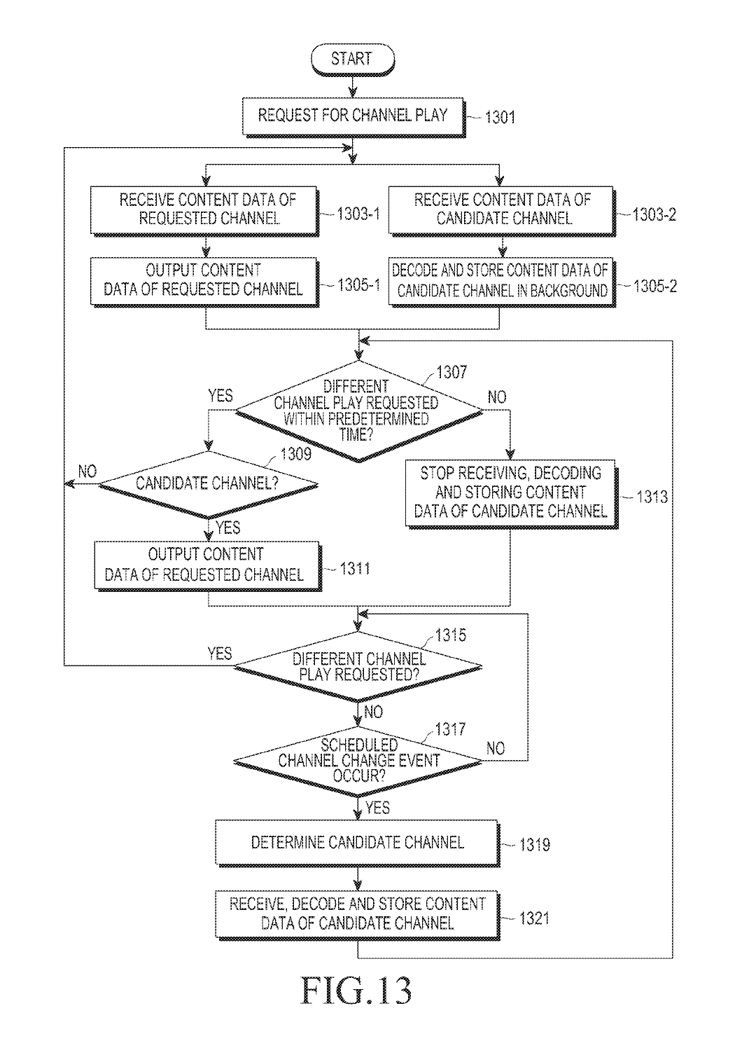

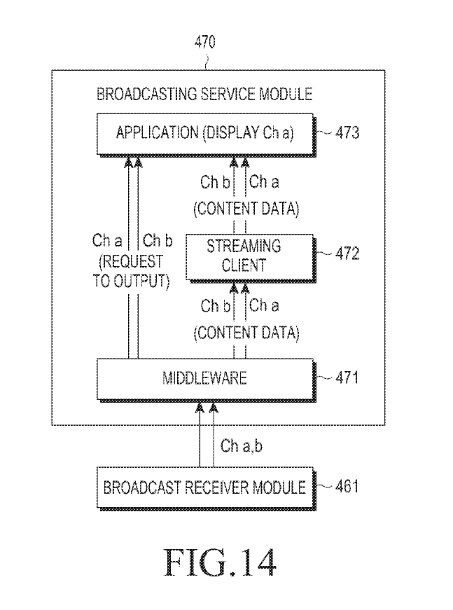

According to another embodiment of the present invention, the middleware 471 may perform background processing on the candidate channel for a predetermined time from when a broadcasting channel selected by the user starts to be output or when a channel change is expected, and upon the expiration of the predetermined time, stop performing background processing on the candidate channel. This embodiment is further described in connection with FIGS. 13 and 14.

FIG. 13 is a flowchart illustrating operations of an electronic device according to another embodiment of the present invention, and FIG. 14 is a diagram illustrating a procedure of processing a broadcasting channel, according to another embodiment of the present invention. FIG. 14 illustrates processing of a broadcasting channel corresponding to steps 1303-1, 1303-2, 1305-1, and 1305-2 of FIG. 13.

Referring to FIG. 13, when the user requests to play a selected channel through the I/O interface 400, in step 1301, the broadcasting service module 470 of the electronic device 400 sends a request for access to the requested broadcasting channel to the broadcast receiver module 461.

Then, the broadcasting service module 470 determines a candidate channel. The candidate channel may be determined to include, for example, n broadcasting channels before the requested broadcasting channel, in a channel sequence. Alternatively, the candidate channel may be determined to include m broadcasting channels after the requested broadcasting channel, in the channel sequence. Alternatively, the candidate channel may be determined to include n broadcasting channels before the requested broadcasting channel and m broadcasting channels after the requested broadcasting channel. Alternatively, the candidate channel may be determined to be the user's preferred channel registered in advance. The broadcasting service module 470 may send a request for access to the determined candidate channel to the broadcast receive module 461.

Upon a request from the broadcasting service module 470, the broadcast receiver module 461 may access the requested broadcasting channel and the candidate channel, receive respective content data of the channels, and forward the content data to the broadcasting service module 470.

Accordingly, the broadcasting service module 470 receives content data of the requested broadcasting channel in step 1303-1, and receives content data of the candidate channel in step 1303-2.

The broadcasting service module 470 allows the user to view the broadcasting channel requested by the user by outputting the content data of the requested broadcasting channel, in step 1305-1. The broadcasting service module 470 also decodes and stores the content data of the candidate channel in the background, in step 1305-2. In other words, the broadcasting service module 470 decodes the content data of the candidate channel to convert the content data into image data and audio data, and buffer the image data and audio data.

For example, assuming that a broadcasting channel selected by the user is Ch a and a candidate channel is Ch b, referring to FIG. 14, content data of Ch a and content data of Ch b received by the broadcast receiver module 461 may be sent to the middleware 471 of the broadcasting service module 470.

The middleware 471 forwards the content data of Ch a to the streaming client 472 and sends a request for output for Ch a to the application 473. The middleware 471 may also forward the content data of Ch b to the streaming client 472, and request the application 473 to reproduce image data of Ch b in the background not to be actually displayed in the display 450.

The streaming client 472 decodes the content data of Ch a into image data and audio data. The streaming client 472 also sends the image data and audio data of Ch a to the application 473 to output the content of Ch a. Accordingly, the user may view a requested broadcasting channel, i.e., Ch a.

The streaming client 472 decodes content data of Ch b to convert the content data into image data and audio data, and sends the image data and audio data of Ch b to the application 473. The application 473 does not output the image data and audio data of Ch b to the user but instead stores the image data and audio data of Ch b for buffering.

Then, if the user's candidate channel play request is received from the application 473 within a predetermined time, the middleware 471 may request the application 473 to output the candidate channel. Accordingly, the application 473 enables the image data and audio data of the candidate channel being buffered to be output to the user.

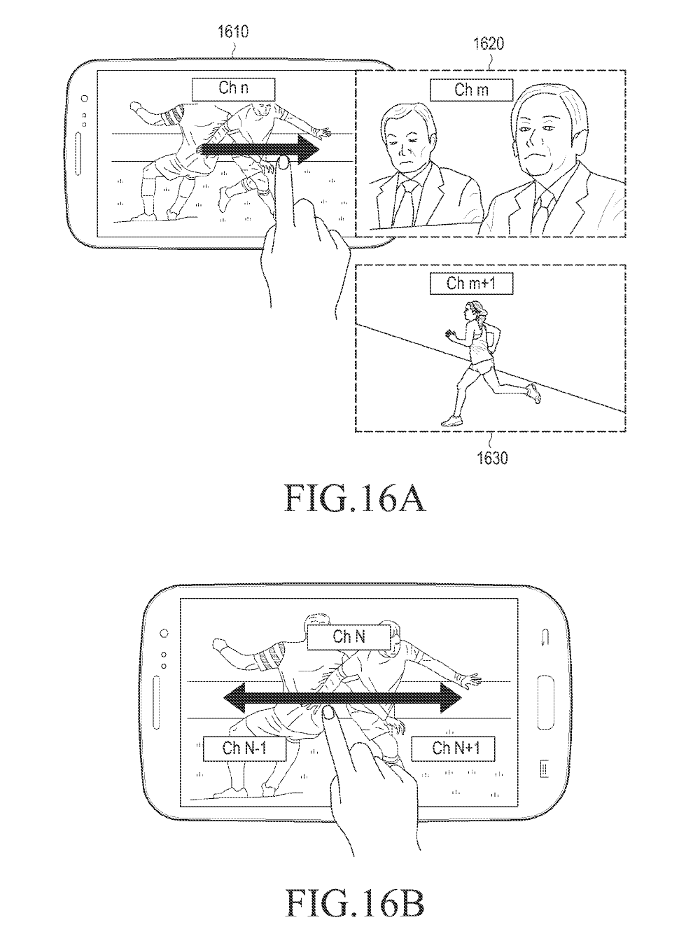

FIG. 16A shows content data of candidate channels reproduced in the background, according to an embodiment of the present invention. Referring to FIG. 16A, the electronic device 400 is outputting an image 1610 of Ch n. Since content data of candidate channels Ch m and Ch m+1 are being reproduced in the background, an image 1620 of Ch m and an image 1630 of Ch m+1 are not actually displayed but are on standby for output.

Turning back to FIG. 13, in step 1307, the broadcasting service module 470 determines whether a request to play a different channel has been received from the user within a predetermined time. If it is determined that the request has been made within the predetermined time, the broadcasting module 470 determines whether the different channel corresponds to one of candidate channels, in step 1309. If it is determined in step 1309 that the different channel corresponds to a candidate channel, the broadcasting service module 470 outputs image data and audio data of the different channel, i.e., a channel requested by the user, among buffered image data and audio data, in step 1311. Accordingly, the broadcasting service module 470 outputs the channel requested by the user without delay due to the channel access.

Referring to FIG. 14, if the different channel is Ch b, the middleware 471 of the broadcasting service module 470 enables the image data and audio data of Ch b being buffered to be output to the user, thereby outputting Ch b to the user without the processing delay.

Turning back to FIG. 13, in step 1307, if no user request to play a different channel has been received within the predetermined time, the broadcasting service module 470 stops receiving, decoding, and storing the content data of the candidate channel, in step 1313.

Then, the broadcasting service module 470 determines whether a request to play a different channel has been made in step 1315, and if the request has been made, proceeds to steps 1303-1 and 1303-2 to access a newly requested channel and candidate channel. If no request to play a different channel has been received, the broadcasting service module 470 determines whether a scheduled channel change event occurs in step 1317.

According to an embodiment of the present invention, the scheduled channel change event may occur when the candidate channel reception condition is met. The scheduled channel change event is an event that occurs at a time when a channel change is predicted.

For example, the scheduled channel change event may occur at the end of or a few seconds before the end of a broadcasting program being viewed by the user. Alternatively, the scheduled channel change event may occur at the start or a few seconds before the start of a new broadcasting program of a previous or next channel to the broadcasting channel being viewed by the user. Alternatively, the scheduled channel change event may occur at the start of or a few seconds before the start of a broadcasting program registered as the user's preferred program.

When the scheduled channel change event occurs, the broadcasting service module 470 determines a candidate channel, in step 1319. The candidate channel may be determined according to what triggers the scheduled channel change event. For example, if the scheduled channel change event occurs in relation to the end of a broadcasting program being viewed by the user, the candidate channel may be determined to be a previous channel or next channel to the channel being viewed by the user. Alternatively, if the scheduled channel change event occurs in relation to the start time of a new broadcasting program of a previous channel or next channel to a broadcasting channel being viewed by the user, the candidate channel may be determined to be the corresponding broadcasting channel. Alternatively, if the scheduled channel change event occurs in relation to the start time of a broadcasting program registered as the user's preferred program, the candidate channel may be determined to be a broadcasting channel that provides the user's preferred program.

Once the candidate channel is determined, the broadcasting service module 470 receives content data of the candidate channel in step 1321, decodes and stores the content data in the background, and proceeds to step 1307.

As such, in preparation for a channel change of the user, the broadcasting service module 470 may access a corresponding broadcasting channel in advance, receive content data, and decode the content data in advance, thereby reducing channel access delay.

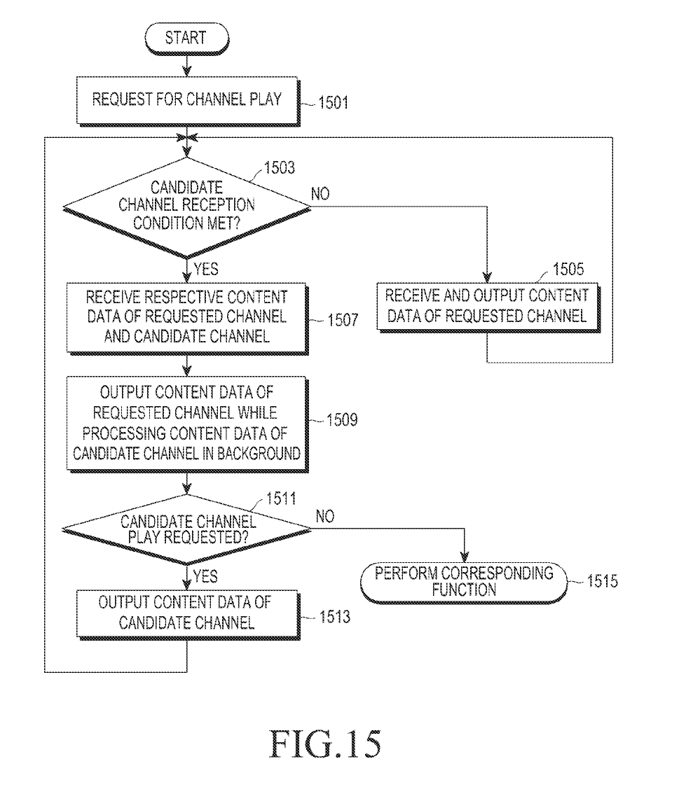

Operations of an electronic device that receive content data of a candidate channel according to whether the candidate channel reception condition is met according to an embodiment of the present invention are described here as follows with reference to FIG. 15.

FIG. 15 is a flowchart illustrating operations of an electronic device, according to another embodiment of the present invention.

Referring to FIG. 15, if there is a request to play a channel, in step 1501, the broadcasting service module 470 of the electronic device 400 determines whether a predetermined candidate channel reception condition is met, in step 1503.

The predetermined candidate channel reception condition may be, for example, a request to play the broadcasting channel. Specifically, if there is a request to play a broadcasting channel, access to the requested channel, (e.g., the first broadcasting channel) and reception of the content data may be performed concurrently with access to a candidate channel (e.g., the second broadcasting channel) and reception of the corresponding content data.

According to an embodiment of the present invention, the predetermined condition may be a request for candidate channel reception directly input to the electronic device 400 or input from another electronic device operationally connected to the electronic device 400.

According to an embodiment of the present invention, the predetermined condition may be context information of at least one of the electronic device 400 and other electronic devices operationally connected to the electronic device 400. If conditions or surroundings of the electronic device 400 or other electronic devices operationally connected to the electronic device 400 correspond to the context information, content data corresponding to a candidate channel may be received automatically. The context information may include information regarding the at least one device, including at least one of location, power status, communication status, time, weather, user schedule, broadcasting schedule, and content type of content data being output.

The broadcasting service module 470 may determine whether at least one candidate channel condition registered in the electronic device 400, among the candidate channel reception conditions, is met.

If it is determined that the candidate channel reception condition is not met in step 1503, the broadcasting service module 470 receives and outputs content data of a channel requested for play, in step 1505. Then, the process proceeds to step 1503 where the broadcasting service module 470 monitors, in real time, whether the candidate channel reception condition is met.

Otherwise, if it is determined that the candidate channel reception condition is not met, the broadcasting service module 470 performs step 1507. In step 1507, the broadcasting service module 470 receives content data of a channel requested for play. Then, the broadcasting service module 470 may determine a candidate channel based on the satisfied candidate channel reception condition, or receive content data of the determined candidate channel.

In step 1509, the broadcasting service module 470 outputs the content data of the channel requested for play while processing the content data of the candidate channel in the background.

Then, if there is a request to play the candidate channel in step 1511, the broadcasting service module 470 outputs content data of the candidate channel in step 1513 and goes back to step 1503. If it is determined that a request other than the request to play the candidate channel occurs in step 1511, the process proceeds to step 1515 to perform a corresponding operation and proceeds to step 1503.

According to another embodiment of the present invention, the electronic device 400 may show a guide to broadcasting channel(s) (candidate channel(s)) immediately movable from a currently viewed channel through any of various user interfaces. For example, if the user touches the touch screen, an indicator that leads to a channel number and user input for a candidate channel may be displayed. In another example, if the user touches the touch screen, an electronic message to guide a candidate channel according to a touching (or swiping) direction may be output.

FIG. 16B is a diagram illustrating a candidate channel guide screen, according to an embodiment of the present invention. Referring to FIG. 16B, a currently output broadcasting channel is Ch N, and the user navigates to Ch N−1 and Ch N+1 according to swiping directions.

According to an embodiment of the present invention, the electronic device performs operations including receiving first content data of a first broadcasting channel and outputting at least a part of the first content data to a display operationally coupled to the electronic device 400, wherein outputting at least a part of the first content data includes receiving second content data of a second broadcasting channel during at least a portion of a time in which the at least a part of the first content data is output. According to an embodiment of the present invention, receiving the first content includes receiving a frame having multiple subframes, wherein the first content is included in one or more subframes exclusive of first and last subframes in the frame, and receiving the second content includes receiving the frame, wherein the second content is included in subframes other than the first and last subframes and the one or more subframes in the frame.

According to an embodiment of the present invention, the first content data and the second content data may be received using the same communication method.

According to an embodiment of the present invention, the first content data and the second content data may be received using different communication methods.

According to an embodiment of the present invention, the first content data and the second content data may be received from different communication networks.

According to an embodiment of the present invention, the first content data may be received from an LTE network while the second content data may be received from a Wi-Fi network.

According to an embodiment of the present invention, receiving the second content may include outputting at least a part of the second content data concurrently with at least a part of the first content data.

According to an embodiment of the present invention, in outputting the at least the part of the first content data, the second content data is not output concurrently with the at least the part of the first content data.

According to an embodiment of the present invention, receiving the second content data includes storing at least a part of the second content data in a memory.

According to an embodiment of the present invention, at least one of the first content data and the second content data may be received in a form of a packet.

According to an embodiment of the present invention, at least a part of the second content data may be automatically received based on a predetermined condition.

According to an embodiment of the present invention, the predetermined condition may include reception of at least a part of the first content data.

According to an embodiment of the present invention, the predetermined condition may include an input to the electronic device 400 or another electronic device operationally connected to the electronic device 400.

According to an embodiment of the present invention, the predetermined condition may include a request for the second broadcasting channel.

According to an embodiment of the present invention, the predetermined condition may include context information regarding at least one of the electronic device 400 and other devices operationally connected to the electronic device 400.

According to an embodiment of the present invention, the context information may include information regarding the at least one device, including at least one of location, power status, communication status, time, weather, broadcasting schedule, user schedule, and content type of the first content data.

According to an embodiment of the present invention, operation of receiving at least one content data corresponding to at least one additional broadcasting channel, based on a request for the second broadcasting channel may be further included.

According to an embodiment of the present invention, the second content data may be stored in the memory in an encoded state.

According to an embodiment of the present invention, the encoded second content data stored in the memory may be decoded and output based on an output request for the second broadcasting channel.

According to an embodiment of the present invention, the second content data of the second broadcasting channel may be stored in the memory in a decoded state.

According to an embodiment of the present invention, the decoded second content data stored in the memory may be output based on a play request for the second broadcasting channel.

According to an embodiment of the present invention, receiving or storing the second content data may be at least temporarily stopped if there has been no request to play the second broadcasting channel for a predetermined time.

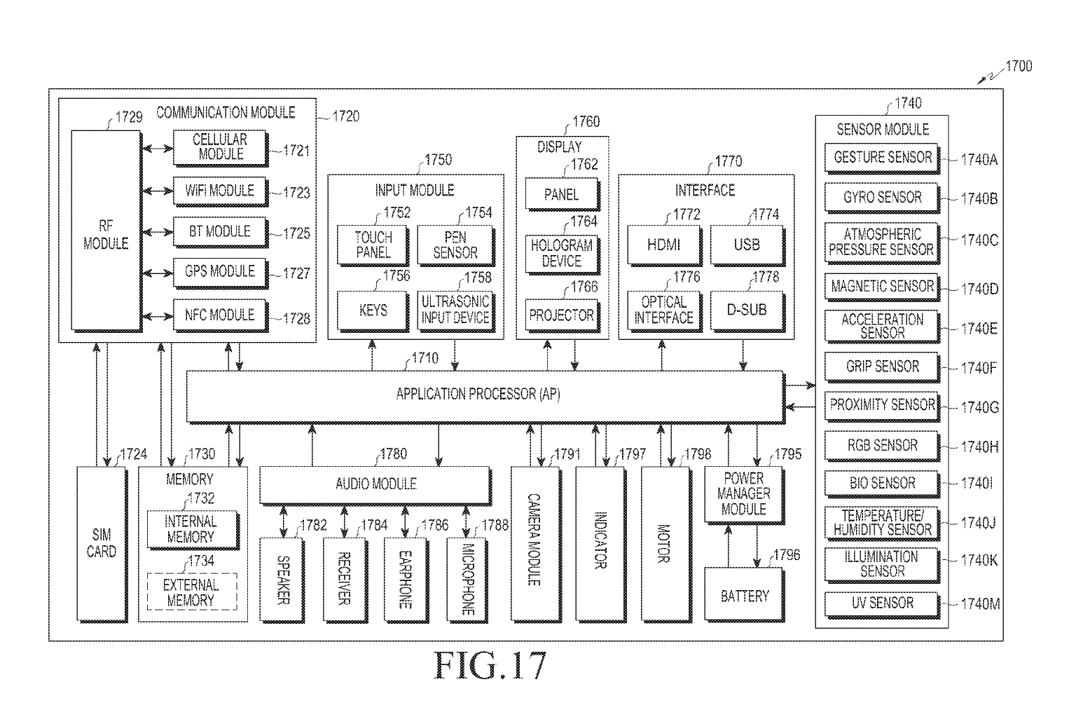

FIG. 17 is a block diagram of an electronic device according to an embodiment of the present invention.

Although not shown in FIG. 17, the electronic device 1700 further includes at least a portion of the electronic device 400 illustrated in FIG. 8, as described in further detail herein.

Referring to FIGS. 17 and 8, the electronic device 1700 includes at least one Application Processor (AP) 1710, a communication module 1720, a Subscriber Identification Module (SIM) card 1724, a memory 1730, a sensor module 1740, an input device 1750, a display 1760, an interface 1770, an audio module 1780, a camera module 1791, a power manager module 1795, a battery 1796, an indicator 1797, a motor 1798, and the broadcasting service module 470.

The AP 1710 controls hardware and software components connected to the AP 1710 by running an operating system or application programs, and performs data processing and operations. The AP 1710 may be implemented in a System on Chip (SoC), for example. In accordance with an embodiment of the present invention, the AP 1710 may further include a Graphic Processing Unit (GPU).

The communication module 1720 (corresponding to the communication interface 460 of FIG. 8) communicates data with other electronic devices, such as the external electronic device 404 and the server 406 connected via a network. In accordance with an embodiment of the present invention, the communication module 1720 includes a cellular module 1721, a Wi-Fi module 1723, a BT module 1725, a GPS module 1727, an NFC module 1728, a Radio Frequency (RF) module 1729, and the broadcast receiver module 461.

The cellular module 1721 provides voice calls, video calls, SMS or Internet services over a communication network, such as LTE, LTE-A, CDMA, WCDMA, UMTS, WiBro, GSM, etc. The cellular module 1721 also identifies and authenticates an electronic device in the communication network in cooperation with the SIM card 1724. In accordance with an embodiment of the present invention, the cellular module 1721 performs at least a part of functions providable by the AP 1710. For example, the cellular module 1721 may perform at least a part of multimedia control function.

According to an embodiment of the present invention, the cellular module 1721 may include a Communication Processor (CP). The cellular module 1721 may also be implemented in an SoC, for example. While the components of FIG. 17, such as the cellular module 1721 (e.g., a CP), the memory 1730 or the power manager module 1795 are illustrated as being separate from the AP 1710, the AP 1710 may incorporate some of the aforementioned components (e.g., the cellular module 1721) in other embodiments of the present invention.

In accordance with an embodiment of the present invention, the AP 1710 or the cellular module 1721 (e.g., a CP) loads a command or data received from at least one of a non-volatile memory or other components connected to the AP 1710 or the cellular module 1721, and then processes the command or data. In addition, the AP 1710 or the cellular module 1721 stores data received from or generated by at least one of the other components in a non-volatile memory.

The Wi-Fi module 1723, the BT module 1725, the GPS module 1727, and the NFC module 1728 may each include a processor for processing data sent or received through the corresponding module. While FIG. 17 illustrates each of the cellular module 1721, the Wi-Fi module 1723, the BT module 1725, the GPS module 1727, and the NFC module 1728 as a separate block, some of these blocks (e.g., two or more blocks) may be incorporated in a single Integrated Chip (IC) or an IC package in other embodiments. For example, at least some of processors corresponding to the cellular module 1721, the Wi-Fi module 1723, the BT module 1725, the GPS module 1727, and the NFC module 1728, e.g., a CP of the cellular module 1721 and a Wi-Fi processor of the Wi-Fi module 1723 may be implemented in a single SoC.

The RF module 1729 may perform data communication, more specifically, RF signal communication. The RF module 1729 may include e.g., a transceiver, a Power Amp Module (PAM), a frequency filter, or a Low Noise Amplifier (LAN) (not shown). The RF module 1729 may further include some parts for wireless communication (i.e., for transmitting or receiving RF signals over the air), such as conductors, wires, etc. While FIG. 17 illustrates the cellular module 1721, the Wi-Fi module 1723, the BT module 1725, the GPS module 1727, and the NFC module 1728 as sharing the single RF module 1729, any of these modules may perform RF signal communication through a separate RF module.

The SIM card 1724 includes a subscriber identification module, which may be inserted into a slot formed in a particular position in the electronic device. The SIM card 1724 may include a unique identification information, such as Integrated Circuit Card Identifier (ICCID), or subscriber information, such as International Mobile Subscriber Identity (IMSI).

The memory 1730 (corresponding to the memory 430) includes at least one of an internal memory 1732 or an external memory 1734. The internal memory 1732 may include, for example, at least one of a volatile memory, such as Dynamic Random Access Memory (DRAM), Static RAM (SRAM), Synchronous Dynamic RAM (SDRAM), etc., or a non-volatile memory, such as One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, Nor flash memory, etc.

According to an embodiment of the present invention, the internal memory 1732 may be a Solid State Drive (SSD). The external memory 1734 may include a flash drive, such as Compact Flash (CF), Secure Digital (SD), Micro Secure Digital (Micro-SD), Mini Secure Digital (Mini-SD), eXtreme Digital (xD), memory stick, etc. The external memory 1734 may be operationally connected to the electronic device 1700 through various interfaces. According to an embodiment of the present invention, the electronic device 1700 may further include a storage device (or a storage medium), such as a hard drive.

The sensor module 1740 measures a physical quantity or converts information measured or detected by monitoring the electronic device 1700 to an electric signal. The sensor module 1740 may include at least one of a gesture sensor 1740A, a gyro sensor 1740B, an atmospheric pressure sensor 1740C, a magnetic sensor 1740D, an acceleration sensor 1740E, a grip sensor 1740F, a proximity sensor 1740G, a color sensor 1740H such as an RGB (Red, Green, Blue) sensor, a bio sensor 1740I, a temperature/humidity sensor 1740J, an illumination sensor 1740K, or an Ultra Violet (UV) sensor 1740M. Additionally or alternatively, the sensor module 1740 may include (not shown) an E-nose sensor, an electromyography (EMG) sensor, an electroencephalogram (EEG) sensor, an electrocardiogram (ECG) sensor, an infrared (IR) sensor, an iris sensor, a finger print sensor, etc. The sensor module 1740 may further include (not shown) a control circuit for controlling at least one or more of the sensors included in the sensor module 540.

The input device 1750 may include a touch panel 1752, a (digital) pen sensor 1754, a key 1756, or an ultrasonic input device 1758. The touch panel 1752 may recognize touch inputs in at least one of capacitive, resistive, infrared, or ultrasonic methods. The touch panel 1752 may further include a control circuit. With the resistive method, physical contact or proximity detection may be possible. The touch panel 1752 may further include a tactile layer. In this regard, the touch panel 1752 may provide the user with a tactile response.

The (digital) pen sensor 1754 may be implemented in a manner identical or similar to the manner in which a touch input of a user is received, or by using a separate sheet for recognition. The key 1756 may include, for example, a physical button, optical key or key pad. The ultrasonic input device 1758 may use an input tool that generates an ultrasonic signal and enable the electronic device 1700 to determine data by sensing the ultrasonic signal to the microphone 1788, thereby enabling wireless recognition. According to an embodiment of the present invention, the electronic device 1700 may receive a user input from an external device, such as a computer or a server through the communication module 1720.

The display 1760 (corresponding to the display 450) includes a panel 1762, a hologram device 1764, or a projector 1766. The panel 1762 may be, for example, a Liquid Crystal Display (LCD), Active Matrix Organic Light Emitting Diodes (AMOLEDs), or the like. The panel 1762 may be implemented to be flexible, transparent, or wearable. The panel 1762 may also be incorporated with the touch panel 1752 in a unit. The hologram device 1764 may display 3-Dimensional (3D) images (holograms) in the air by using light interference. The projector 1766 displays an image by projecting light onto a screen. The screen may be, for example, located inside or outside of the electronic device 1700. In accordance with an embodiment of the present invention, the display 1760 may further include a control circuit to control the panel 1762, the hologram device 1764, or the projector 1766.

The interface 1770 may include, for example, a High Definition Multimedia Interface (HDMI) 1772, a USB 1774, an optical interface 1776, or a D-subminiature (D-sub) 1778. The interface 1770 may be included in, for example, the communication interface 460 shown in FIG. 8. Additionally or alternatively, the interface 1770 may include a Mobile High-definition Link (MHL) interface, an SD card/MultiMedia Card (MMC) interface, or an InfraRed Data Association (IrDA) standard interface.

The audio module 1780 converts a sound to an electric signal or vice versa. At least a part of the audio module 1780 may be included in e.g., the I/O interface 440, such as shown in FIG. 8. The audio module 1780 may process sound information input or output through e.g., a speaker 1782, a receiver 1784, an earphone 1786, or a microphone 1788.

The camera module 1791 is a device for capturing still images and videos, and may include one or more image sensors (e.g., front and back sensors), a lens, an Image Signal Processor (ISP), or a flash, such as an LED or a xenon lamp.

The power manager module 1795 manages power of the electronic device 1700. Although not shown, a Power management Integrated Circuit (PMIC), a charger IC, or a battery or fuel gauge, for example, may be included in the power manager module 1795.

The PMIC may be mounted on, for example, an IC or an SOC. A charging method may be divided into wired and wireless charging methods. The charger IC may charge a battery and prevent overvoltage or overcurrent from being induced from a charger. According to an embodiment of the present invention, the charger IC may be used in at least one of a cable charging scheme and a wireless charging scheme. The wireless charging scheme may include, for example, a magnetic resonance scheme, a magnetic induction scheme, or an electromagnetic wave based scheme, and an additional circuit, such as a coil loop, a resonance circuit, a rectifier, or the like may be added for wireless charging.

The battery gauge may measure an amount of remaining power of the battery 696, a voltage, a current, or a temperature while the battery 1796 is being charged. The battery 1796 may save or generate electricity, and supply power to the electronic device 1700 with the saved or generated electricity. The battery 1796 may include, for example, a rechargeable battery or a solar battery.

The indicator 1797 indicates a particular state of the electronic device 1700 or of a part of the electronic device (e.g., the AP 1710), the particular state including, for example, a booting state, a message state, or charging state. The motor 1798 converts electric signals to mechanical vibration. Although not shown, a processing unit for supporting mobile TV, such as a GPU may be included in the electronic device 1700. The processing unit for supporting mobile TV may process media data conforming to a standard for Digital Multimedia Broadcasting (DMB), Digital Video Broadcasting (DVB), or media flow.

Each of the aforementioned components of the electronic device may include one or more parts, and a name of the part may vary with a type of the electronic device. The electronic device in accordance with various embodiments of the present invention may include at least one of the aforementioned components, omit some of them, or include other additional component(s). Some of the components may be combined into an entity, but the entity may perform the same functions as the components may do.

The term ‘module’ may refer to a unit including one of hardware, software, and firmware, or a combination thereof. The term ‘module’ may be interchangeably used with a unit, logic, logical block, component, or circuit. The module may be a minimum unit or part of an integrated component. The module may be a minimum unit or part of performing one or more functions. The module may be mechanically or electrically implemented. For example, the module may include at least one of Application Specific Integrated Circuit (ASIC) chips, Field Programmable Gate Arrays (FPGAs), or Programmable Logic Arrays (PLAs) that perform some operations, which have already been known or will be developed in the future.

At least a part of the device (e.g., modules or their functions) or method (e.g., operations) may be implemented as instructions stored in a computer-readable storage medium, for example, in the form of a programming module. The instructions, when executed by one or more processors (e.g., the processor 420), may cause the processor to carry out a corresponding function. The computer-readable storage medium may be e.g., the memory 430. At least a part of the programming module may be implemented by the processor 420, for example. At least a part of the programming module may include, for example, a module, program, routine, set of instructions, process, etc., for performing one or more functions.

The computer-readable storage medium may include a hardware device configured to store and perform program instructions (e.g., a programming module), such as magnetic media such as hard discs, floppy discs, and magnetic tapes, optical media such as Compact Disc ROMs (CD-ROMs) and Digital Versatile Discs (DVDs), magneto-optical media such as floptical disks, ROMs, RAMs, Flash Memories, and/or the like. Examples of the program instructions may include, not only machine language codes, but also high-level language codes which are executable by various computing means using an interpreter. The aforementioned hardware devices may be configured to operate as one or more software modules to carry out various embodiments of the present invention, and vice versa. According to an embodiment of the present invention, provided is a computer-readable medium having a program stored thereon, when executed by the processor 420 of the electronic device 400, for carrying out operations including: receiving first content data of a first broadcasting channel and outputting at least a part of the first content data to a display operationally coupled to the electronic device 400, wherein outputting at least a part of the first content data includes receiving second content data of a second broadcasting channel at least temporarily.

Modules or programming modules in accordance with various embodiments of the present invention may include at least one or more of the aforementioned components, omit some of them, or further include other additional components. Operations performed by modules, programming modules or other components in accordance with various embodiments of the present invention may be carried out sequentially, simultaneously, repeatedly, or heuristically. Furthermore, some of the operations may be performed in a different order, or omitted, or include other additional operation(s).

According to the embodiments of the present invention, by receiving multimedia content packet data from multiple broadcasting channels simultaneously, delay in connection to a new channel in channel change is, reduced and therefore, user convenience is increased.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method in an electronic device, the method comprising:
receiving first content data corresponding to a first broadcasting channel while receiving second content data corresponding to a second broadcasting channel; and
outputting at least a part of the received first content data to a display connected to the electronic device.

2. The method of claim 1, further comprising outputting the second content data to the display, if a request to play the second broadcasting channel is received while the at least the part of the received first content data is output.

3. The method of claim 2, wherein outputting the second content data comprises outputting at least a part of the second content data concurrently with the at least the part of the received first content data.

4. The method of claim 1, wherein the second content data is not output during output of the at least the part of the received first content data.

5. The method of claim 4, wherein the receiving second content data comprises storing at least a part of the received second content data in a memory.

6. The method of claim 1, wherein at least a part of the second content data is automatically received based on a predetermined condition.

7. The method of claim 6, wherein the predetermined condition comprises reception of at least a part of the first content data.

8. The method of claim 6, wherein the predetermined condition comprises an input to at least one of the electronic device and another electronic device connected to the electronic device.

9. The method of claim 1, wherein, when the second content data is stored in a memory in an encoded state, and the stored second content data is decoded for output based on a request to play the second broadcasting channel.

10. The method of claim 1, wherein the second content data corresponding to the second broadcasting channel is stored in a memory in a decoded state, and the stored second content data is output based on a request to play the second broadcasting channel.

11. The method of claim 1, wherein, if a request to play the second broadcasting channel is not received within a predetermined time while the at least the part of the received first content data is output, stopping reception and processing of the second content data, while continuing to output the at least the part of the received first content data.

12. An electronic device comprising:
a memory for storing content data; and
a broadcasting service module connected to the memory,
wherein the broadcasting service module is configured to receive first content data corresponding to a first broadcasting channel while receiving second content data corresponding to a second broadcasting channel, and output at least a part of the received first content data to a display connected to the electronic device.

13. The electronic device of claim 12, wherein the broadcasting service module is further configured to output the second content data to the display, if a request to play the second broadcasting channel is received while the at least the part of the received first content data is output.

14. The electronic device of claim 12, wherein the memory is configured to store the second content data in the memory in an encoded state, and
wherein the broadcasting service module is further configured to decode the stored second content data and output the decoded second content data, based on a request to play the second broadcasting channel.

15. The electronic device of claim 12, wherein the memory is configured to store the second content data corresponding to the second broadcasting channel in the memory in a decoded state, and
wherein the broadcasting service module is further configured to output the stored second content data, based on a request to play the second broadcasting channel.

16. The electronic device of claim 12, wherein the broadcasting service module is further configured to receive at least one content data corresponding to at least one additional broadcasting channel, based on a request to play the second broadcasting channel.

17. The electronic device of claim 12, wherein the broadcasting service module is further configured to stop receiving and processing the second content data at least temporarily, while continuing to output the at least the part of the received first content data, if a request to play the second broadcasting channel is not received within a predetermined time while the at least the part of the received first content data is output.

18. The electronic device of claim 12, wherein the broadcasting service module is further configured to automatically determine the second broadcasting channel based on context information regarding at least one of the electronic device and other devices connected to the electronic device.

19. The electronic device of claim 18, wherein the context information comprises information regarding the at least one device, including at least one of location, power status, communication status, time, weather, broadcasting schedule, user schedule, and content type of the first content data.

20. A non-transitory computer-readable recording medium having a program stored thereon for performing a method comprising:
receiving first content data corresponding to a first broadcasting channel in an electronic device while receiving second content data corresponding to a second broadcasting channel;
outputting at least a part of the received first content data to a display connected to the electronic device; and
processing, while outputting the at least the part of the received first content data, at least a part of the received second content data, the processing including at least one of buffering and reproducing the at least the part of the received second content data.
